(19) United States
(12) Patent Application Publication
(10) Pub. No.: US 2026/0326725 A1
(43) Pub. Date: Oct. 22, 2026

(54) PEDAL SYSTEM FOR A VEHICLE

(71) Applicant: HL MANDO CORPORATION, Gyeonggi-do (KR)

(72) Inventors: SooYong JEON, Gyeonggi-do (KR); Heejun KIM, Gyeonggi-do (KR); Hyundong KIM, Gyeonggi-do (KR); Sungjun HONG, Gyeonggi-do (KR)

(21) Appl. No.: 19/650,284

(22) Filed: Apr. 16, 2026

(30) Foreign Application Priority Data
Apr. 17, 2025 (KR) 10-2025-0050096

(51) Int. Cl. B60T 7/04; B60K 26/02; G05G 5/03

(52) U.S. Cl. CPC B60T 7/042; B60K 26/021; G05G 5/03; B60T 2220/04; G05G 2505/00

(57) ABSTRACT

A pedal system for a vehicle is disclosed. The pedal system for a vehicle may include a pedal mounted to the vehicle; a pedal simulator connected to the pedal and configured to provide, to the pedal, a reaction force corresponding to a pressure applied to the pedal; a first sensor configured to detect information related to operation of the pedal; a second sensor configured to detect information related to operation of the pedal simulator; and a controller configured to brake or accelerate the vehicle using at least one of sensing information of the first sensor or sensing information of the second sensor.

### CROSS-REFERENCE TO RELATED APPLICATION

This application claims priority to and benefit from Korean Patent Application No.10-2025-0050096, filed on Apr. 17, 2025, the disclosure of which is incorporated herein by reference to the extent permitted by law.

### Technical Field

The present disclosure relates to a pedal system for a vehicle, and more particularly, to a pedal system for a vehicle that brakes or accelerates the vehicle based on operation information of a pedal mounted to the vehicle.

### Related Art

A vehicle is provided with an accelerator pedal for acceleration of the vehicle and a brake pedal for deceleration of the vehicle. Recently, as various electronic control functions have been mounted to vehicles, pedal systems have been widely used in which, when a driver of a vehicle depresses a pedal of the vehicle, a sensor detects operation of the pedal, and braking of the vehicle or the like is performed based on a result of the detection.

In such a pedal system for a vehicle, when operation information of the pedal is not accurately detected, control of the vehicle according to an intention of the driver cannot be achieved. In particular, when operation information of the brake pedal is incorrectly detected or is not detected, an accident of the vehicle may occur.

### SUMMARY

An object of the present disclosure is to provide a pedal system for a vehicle capable of accurately recognizing operation information of a pedal mounted to the vehicle.

Another object of the present disclosure is to provide a pedal system having improved reliability of a function related to recognition of operation of a pedal mounted to the vehicle.

Still another object of the present disclosure is to provide a pedal system securing redundancy of a function related to recognition of operation of a pedal mounted to the vehicle.

The objects of the present disclosure are not limited to the above-described objects, and other objects that are not mentioned will be able to be clearly understood by those skilled in the art to which the present disclosure pertains from the following description.

According to an aspect of the present disclosure, provided is a pedal system for a vehicle, comprising a pedal mounted to the vehicle; a pedal simulator connected to the pedal and configured to provide, to the pedal, a reaction force corresponding to a pressure applied to the pedal; a first sensor configured to detect information related to operation of the pedal; a second sensor configured to detect information related to operation of the pedal simulator; and a controller configured to operate the vehicle using at least one of sensing information of the first sensor or sensing information of the second sensor.

In the pedal system for a vehicle according to an aspect of the present disclosure, the controller may brake or accelerate the vehicle based on an average value of the sensing information of the first sensor and the sensing information of the second sensor if a difference between the sensing information of the first sensor and the sensing information of the second sensor is within a set range.

In the pedal system for a vehicle according to an aspect of the present disclosure, the controller may brake or accelerate the vehicle based on one of the sensing information of the first sensor or the sensing information of the second sensor if a difference between the sensing information of the first sensor and the sensing information of the second sensor is within a set range.

In the pedal system for a vehicle according to an aspect of the present disclosure, the pedal may be a brake pedal, and the controller may brake the vehicle based on a greater value between the sensing information of the first sensor and the sensing information of the second sensor if a difference between the sensing information of the first sensor and the sensing information of the second sensor is outside a set range.

In the pedal system for a vehicle according to an aspect of the present disclosure, the pedal may be an accelerator pedal, and the controller may accelerate the vehicle based on a smaller value between the sensing information of the first sensor and the sensing information of the second sensor if a difference between the sensing information of the first sensor and the sensing information of the second sensor is outside a set range.

In the pedal system for a vehicle according to an aspect of the present disclosure, the first sensor may detect one of linear displacement of the pedal, angular displacement of the pedal, or a force applied to the pedal.

In the pedal system for a vehicle according to an aspect of the present disclosure, the pedal simulator may include a housing defining a chamber therein; a damper disposed inside the housing; and a piston connected to the pedal and disposed in the chamber to press the damper when pressure is applied to the pedal, and the second sensor may detect linear displacement of the piston or a pressure applied to the damper.

In the pedal system for a vehicle according to an aspect of the present disclosure, the pedal simulator may include a housing defining a chamber filled with a fluid therein; and a piston connected to the pedal and disposed in the chamber to cause the fluid to flow when pressure is applied to the pedal, and the second sensor may detect a flow pressure of the fluid.

According to another aspect of the present disclosure, provided is a pedal system for a vehicle, comprising a pedal mounted to the vehicle; a pedal simulator connected to the pedal and configured to provide a reaction force corresponding to a pressure applied to the pedal; a first pedal simulator sensor disposed in the pedal simulator and configured to detect information related to operation of the pedal simulator; a second pedal simulator sensor separately disposed in the pedal simulator from the first pedal simulator sensor and configured to detect information related to operation of the pedal simulator; and a controller configured to operate the vehicle using at least one of sensing information of the first pedal simulator sensor or sensing information of the second pedal simulator sensor.

In the pedal system for a vehicle according to another aspect of the present disclosure, the pedal may be a brake pedal, and the controller may brake the vehicle based on a greater value between the sensing information of the first pedal simulator sensor and the sensing information of the second pedal simulator sensor if a difference between the sensing information of the first pedal simulator sensor and the sensing information of the second pedal simulator sensor is outside a set range.

In the pedal system for a vehicle according to another aspect of the present disclosure, the pedal may be an accelerator pedal, and the controller may accelerate the vehicle based on a smaller value between the sensing information of the first pedal simulator sensor and the sensing information of the second pedal simulator sensor if a difference between the sensing information of the first pedal simulator sensor and the sensing information of the second pedal simulator sensor is outside a set range.

In the pedal system for a vehicle according to another aspect of the present disclosure, the pedal simulator may include a housing defining a chamber therein; a damper disposed inside the housing; and a piston connected to the pedal and disposed in the chamber to press the damper when pressure is applied to the pedal, and the first pedal simulator sensor may detect linear displacement of the piston, and the second pedal simulator sensor may detect a pressure applied to the damper.

In the pedal system for a vehicle according to another aspect of the present disclosure, the pedal simulator may include a housing defining a chamber filled with a fluid therein; and a piston connected to the pedal and disposed in the chamber to cause the fluid to flow when pressure is applied to the pedal, and the first pedal simulator sensor may detect linear displacement of the piston, and the second pedal simulator sensor may detect a flow pressure of the fluid.

In the pedal system for a vehicle according to another aspect of the present disclosure, the pedal simulator may include a housing defining a chamber filled with a fluid therein; a damper disposed inside the housing; and a piston connected to the pedal and disposed in the chamber to press the damper and cause the fluid to flow when pressure is applied to the pedal, and the first pedal simulator sensor may detect a pressure applied to the damper, and the second pedal simulator sensor may detect a flow pressure of the fluid.

According to still another aspect of the present disclosure, provided is a pedal system for a vehicle, comprising a pedal mounted to the vehicle; a pedal simulator connected to the pedal and configured to provide a reaction force corresponding to a pressure applied to the pedal; a first pedal sensor configured to detect information related to operation of the pedal; a second pedal sensor separately disposed from the first pedal sensor and configured to detect information related to operation of the pedal; and a controller configured to operate the vehicle using at least one of sensing information of the first pedal sensor or sensing information of the second pedal sensor.

In the pedal system for a vehicle according to still another aspect of the present disclosure, the pedal may be a brake pedal, and the controller may brake the vehicle based on a greater value between the sensing information of the first pedal sensor and the sensing information of the second pedal sensor if a difference between the sensing information of the first pedal sensor and the sensing information of the second pedal sensor is outside a set range.

In the pedal system for a vehicle according to still another aspect of the present disclosure, the pedal may be an accelerator pedal, and the controller may accelerate the vehicle based on a smaller value between the sensing information of the first pedal sensor and the sensing information of the second pedal sensor if a difference between the sensing information of the first pedal sensor and the sensing information of the second pedal sensor is outside a set range.

In the pedal system for a vehicle according to still another aspect of the present disclosure, the first pedal sensor may detect linear displacement of the pedal, and the second pedal sensor may detect angular displacement of the pedal.

In the pedal system for a vehicle according to still another aspect of the present disclosure, the first pedal sensor may detect linear displacement of the pedal, and the second pedal sensor may detect a force applied to the pedal.

In the pedal system for a vehicle according to still another aspect of the present disclosure, the first pedal sensor may detect angular displacement of the pedal, and the second pedal sensor may detect a force applied to the pedal.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a view illustrating a configuration of a pedal system for a vehicle according to a first embodiment of the present disclosure.

FIG. 2 is a view illustrating another example of a second sensor of the pedal system for a vehicle according to the first embodiment of the present disclosure.

FIG. 3 is a view illustrating still another example of the second sensor of the pedal system for a vehicle according to the first embodiment of the present disclosure.

FIG. 4 is a view illustrating a configuration of a pedal system for a vehicle according to a second embodiment of the present disclosure.

FIG. 5 is a view illustrating another example of a combination of a first pedal simulator sensor and a second pedal simulator sensor of the pedal system for a vehicle according to the second embodiment of the present disclosure.

FIG. 6 is a view illustrating still another example of the combination of the first pedal simulator sensor and the second pedal simulator sensor of the pedal system for a vehicle according to the second embodiment of the present disclosure.

FIG. 7 is a view illustrating a configuration of a pedal system for a vehicle according to a third embodiment of the present disclosure.

FIG. 8 is a view illustrating a configuration of a pedal system for a vehicle according to a fourth embodiment of the present disclosure.

FIG. 9 is a view illustrating a configuration of a pedal system for a vehicle according to a fifth embodiment of the present disclosure.

FIG. 10 is a view illustrating a configuration of a pedal system for a vehicle according to a sixth embodiment of the present disclosure.

### DETAILED DESCRIPTION OF EXEMPLARY EMBODIMENTS

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

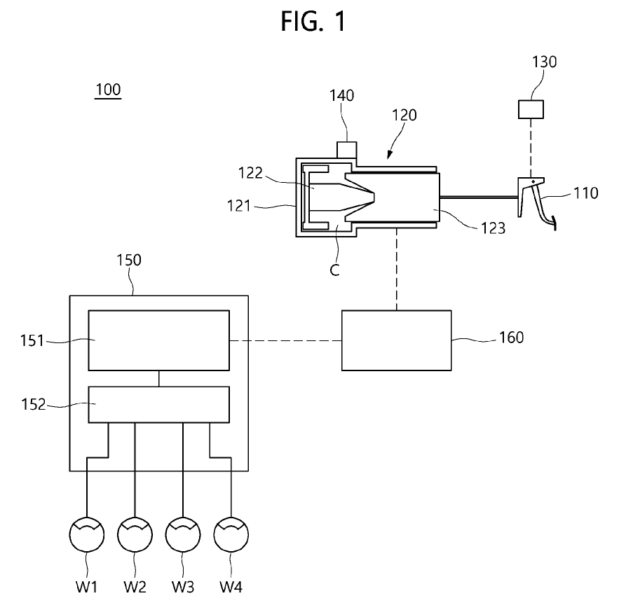

FIG. 1 is a view illustrating a configuration of a pedal system for a vehicle according to a first embodiment of the present disclosure.

A pedal system 100 for a vehicle according to the first embodiment of the present disclosure may brake the vehicle based on operation information of a pedal 110 mounted to the vehicle. In other words, the pedal system 100 for a vehicle may be a brake pedal system of the vehicle.

Referring to FIG. 1, the pedal system 100 for a vehicle according to the first embodiment of the present disclosure includes a pedal 110, a pedal simulator 120, a first sensor 130, a second sensor 140, a brake actuation device 150, and a controller 160.

The pedal 110 is mounted to the vehicle. The pedal 110 may be operated by a driver. In the first embodiment of the present disclosure, the pedal 110 may be a brake pedal.

The pedal simulator 120 is connected to the pedal 110 and provides, to the pedal 110, a reaction force corresponding to a pressure applied to the pedal 110.

The pedal simulator 120 may include a housing 121 defining a chamber C therein, a damper 122 disposed inside the housing 121, and a piston 123 connected to the pedal 110 and disposed in the chamber C to press the damper 122 when pressure is applied to the pedal 110.

The chamber C of the pedal simulator 120 may not be filled with a fluid therein. In this case, the pedal simulator 120 may be defined as a dry type. Meanwhile, the chamber C of the pedal simulator 120 may be filled with a fluid therein. In this case, the pedal simulator 120 may be defined as a wet type.

The first sensor 130 detects information related to operation of the pedal 110. The first sensor 130 may be connected to the pedal 110.

In the first embodiment of the present disclosure, the first sensor 130 may detect linear displacement of the pedal 110. Alternatively, the first sensor 130 may detect angular displacement of the pedal 110. Meanwhile, the first sensor 130 may also detect a force applied to the pedal 110.

The second sensor 140 detects information related to operation of the pedal simulator 120. The second sensor 140 may be disposed inside or outside the pedal simulator 120. More specifically, the second sensor 140 may detect linear displacement of the piston 123.

More specifically, the second sensor 140 may detect the linear displacement of the piston 123 in an electromagnetic manner. For example, the pedal simulator 120 may include a magnet moving together with the piston 123, and the second sensor 140 may detect an intensity or change of a magnetic field formed by the magnet when the piston 123 is displaced.

The brake actuation device 150 performs braking of the vehicle under control of the controller 160. The brake actuation device 150 may supply a fluid to at least one of wheels W1, W2, W3, and W4 of the vehicle to provide a braking pressure.

The brake actuation device 150 may include an actuator 151 generating a pressure of the fluid and a hydraulic circuit 152 regulating a flow of the fluid between the actuator 151 and the wheels W1, W2, W3, and W4 of the vehicle. For example, the actuator 151 may be a motor pump. In addition, the hydraulic circuit 152 may include a flow path connecting the actuator 151 and the wheels W1, W2, W3, and W4 of the vehicle, and one or more valves regulating the flow of the fluid.

The controller 160 may brake the vehicle using at least one of sensing information of the first sensor 130 or sensing information of the second sensor 140. For example, the controller 160 may determine a magnitude of displacement of the pedal 110 using at least one of the sensing information of the first sensor 130 or the sensing information of the second sensor 140, and may control the actuator 151 of the brake actuation device 150 such that a braking force corresponding thereto is generated.

The controller 160 may be configured as an MCU (Micro Controller Unit) or an ECU (Electronic Control Unit) mounted to the vehicle. The controller 160 may include at least one ALU (Arithmetic Logic Unit) and a processing register. In addition, the controller 160 may include a memory for storing data. In addition, the controller 160 may be a single control unit or may include a plurality of distributed control units.

The controller 160 may perform control in various manners. Hereinafter, several examples of a control manner of the controller 160 will be described.

First, if a difference between the sensing information of the first sensor 130 and the sensing information of the second sensor 140 is within a set range, the controller 160 may brake the vehicle based on an average value of the sensing information of the first sensor 130 and the sensing information of the second sensor 140. For example, the set range may be set to a maximum error between the sensing information of the first sensor 130 and the sensing information of the second sensor 140 when both the first sensor 130 and the second sensor 140 are normal.

If the difference between the sensing information of the first sensor 130 and the sensing information of the second sensor 140 is within the set range, both the first sensor 130 and the second sensor 140 may be regarded as operating normally. Accordingly, the controller 160 may determine that the pedal 110 has been displaced by a magnitude corresponding to the average value of the sensing information of the first sensor 130 and the sensing information of the second sensor 140, and may generate a control signal corresponding to the average value of the sensing information of the first sensor 130 and the sensing information of the second sensor 140 and transmit the control signal to the actuator 151 of the brake actuation device 150.

Next, if the difference between the sensing information of the first sensor 130 and the sensing information of the second sensor 140 is within the set range, the controller 160 may brake the vehicle based on one of the sensing information of the first sensor 130 or the sensing information of the second sensor 140. For example, the set range may be set to a maximum error between the sensing information of the first sensor 130 and the sensing information of the second sensor 140 when both the first sensor 130 and the second sensor 140 are normal.

If the difference between the sensing information of the first sensor 130 and the sensing information of the second sensor 140 is within the set range, both the first sensor 130 and the second sensor 140 may be regarded as operating normally. In this case, the controller 160 may use only the sensing information of the first sensor 130 or only the sensing information of the second sensor 140 according to a preset criterion. In this regard, when both the first sensor 130 and the second sensor 140 are normal, the controller 160 may store preset information regarding which sensor is to be preferentially used.

Meanwhile, if the difference between the sensing information of the first sensor 130 and the sensing information of the second sensor 140 is outside the set range, the controller 160 may brake the vehicle based on a greater value between the sensing information of the first sensor 130 and the sensing information of the second sensor 140. For example, the set range may be set to a maximum error between the sensing information of the first sensor 130 and the sensing information of the second sensor 140 when both the first sensor 130 and the second sensor 140 are normal.

if the difference between the sensing information of the first sensor 130 and the sensing information of the second sensor 140 is outside the set range, at least one of the first sensor 130 and the second sensor 140 may be regarded as being faulty. Since the pedal system 100 for a vehicle according to the first embodiment of the present disclosure is related to braking of the vehicle, it is desirable, for safety, that excessive braking rather than insufficient braking be performed. Accordingly, if the difference between the sensing information of the first sensor 130 and the sensing information of the second sensor 140 is outside the set range, the controller 160 may control the actuator 151 of the brake actuation device 150 such that a braking force corresponding to the greater value between the sensing information of the first sensor 130 and the sensing information of the second sensor 140 is generated. Meanwhile, the controller 160 may also control the vehicle to stop.

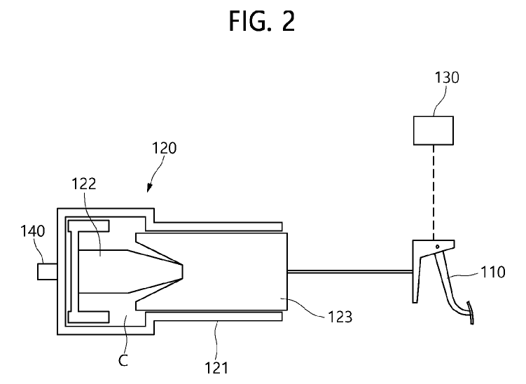

FIG. 2 is a view illustrating another example of a second sensor of the pedal system for a vehicle according to the first embodiment of the present disclosure.

Referring to FIG. 2, the second sensor 140 may detect a pressure applied to the damper 122. For example, the second sensor 140 may be a force sensor disposed to detect the pressure applied to the damper 122.

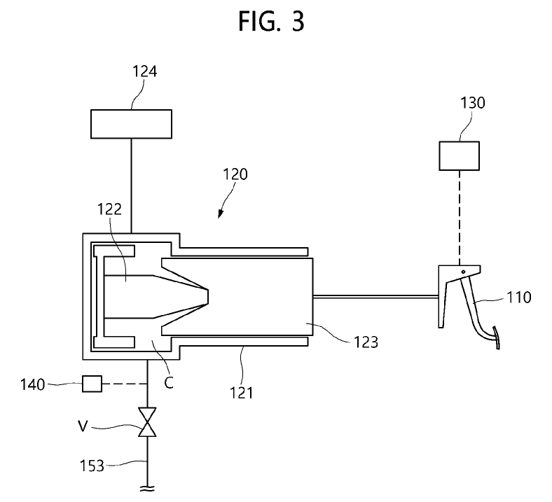

FIG. 3 is a view illustrating still another example of the second sensor of the pedal system for a vehicle according to the first embodiment of the present disclosure.

Referring to FIG. 3, the pedal simulator 120 is configured as a wet type in which the chamber C is filled with a fluid. When the fluid is filled in the pedal simulator 120 as described above, the pedal simulator 120 may be connected to an emergency hydraulic circuit 153 capable of delivering the fluid toward at least one wheel in a fall-back mode of the brake actuation device 150, that is, in a failure state.

When the brake actuation device 150 is in a normal state, a circuit opening/closing valve V disposed in the emergency hydraulic circuit 153 is disposed to close a flow path. At this time, the second sensor 140 may be disposed in the emergency hydraulic circuit 153 between the pedal simulator 120 and the circuit opening/closing valve V. More specifically, the second sensor 140 may detect a flow pressure of the fluid generated when the piston 123 is displaced by a pressure applied to the pedal 110.

When the brake actuation device 150 is in a normal state, the fluid does not need to be supplied to the emergency hydraulic circuit 153. In this regard, the pedal simulator 120 may further include a reservoir 124 for accommodating a flow of the fluid from the chamber C according to displacement of the pedal 110.

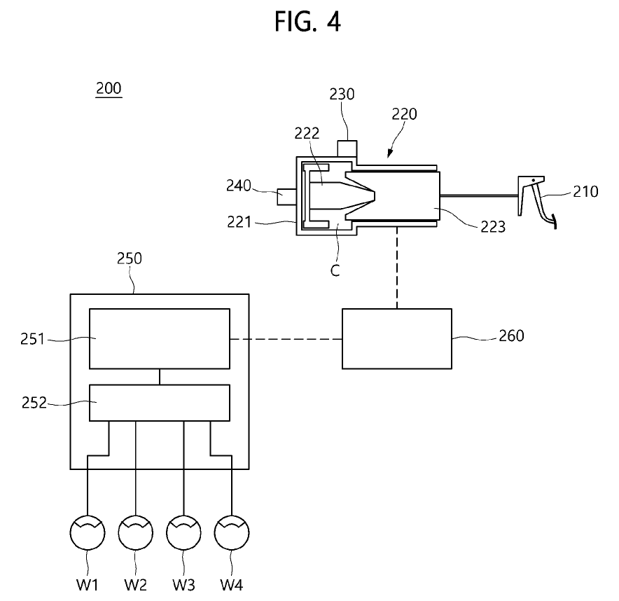

FIG. 4 is a view illustrating a configuration of a pedal system for a vehicle according to a second embodiment of the present disclosure.

A pedal system 200 for a vehicle according to the second embodiment of the present disclosure may brake the vehicle based on operation information of a pedal 210 mounted to the vehicle. In other words, the pedal system 200 for a vehicle may be a brake pedal system of the vehicle.

Referring to FIG. 4, the pedal system 200 for a vehicle according to the second embodiment of the present disclosure includes a pedal 210, a pedal simulator 220, a first pedal simulator sensor 230, a second pedal simulator sensor 240, a brake actuation device 250, and a controller 260.

The pedal 210 is mounted to the vehicle. The pedal 210 may be a brake pedal.

The pedal simulator 220 is connected to the pedal 210 and provides, to the pedal 210, a reaction force corresponding to a pressure applied to the pedal 210.

The pedal simulator 220 may include a housing 221 defining a chamber C therein, a damper 222 disposed inside the housing 221, and a piston 223 connected to the pedal 210 and disposed in the chamber C to press the damper 222 when pressure is applied to the pedal 210.

The first pedal simulator sensor 230 is disposed in the pedal simulator 220 and detects information related to operation of the pedal simulator 220. The first pedal simulator sensor 230 may be disposed inside or outside the pedal simulator 220. For example, the first pedal simulator sensor 230 may detect linear displacement of the piston 223.

More specifically, the first pedal simulator sensor 230 may detect the linear displacement of the piston 223 in an electromagnetic manner. For example, the pedal simulator 220 may include a magnet moving together with the piston 223, and the first pedal simulator sensor 230 may detect an intensity or change of a magnetic field formed by the magnet when the piston 223 is displaced.

The second pedal simulator sensor 240 is separately disposed in the pedal simulator 220 from the first pedal simulator sensor 230 and detects information related to operation of the pedal simulator 220. In the second embodiment of the present disclosure, the second pedal simulator sensor 240 may detect a pressure applied to the damper 222. That is, the second pedal simulator sensor 240 may be a force sensor disposed to detect the pressure applied to the damper 222.

The brake actuation device 250 performs braking of the vehicle under control of the controller 260. The brake actuation device 250 may supply a fluid to at least one of wheels W1, W2, W3, and W4 of the vehicle to provide a braking pressure.

The brake actuation device 250 may include an actuator 251 generating a pressure of the fluid and a hydraulic circuit 252 regulating a flow of the fluid between the actuator 251 and the wheels W1, W2, W3, and W4 of the vehicle.

The controller 260 brakes the vehicle using at least one of sensing information of the first pedal simulator sensor 230 or sensing information of the second pedal simulator sensor 240. More specifically, the controller 260 may determine a magnitude of displacement of the pedal 210 using at least one of the sensing information of the first pedal simulator sensor 230 or the sensing information of the second pedal simulator sensor 240, and may control the actuator 251 of the brake actuation device 250 such that a braking force corresponding thereto is generated.

The controller 260 may perform control in various manners.

First, if a difference between the sensing information of the first pedal simulator sensor 230 and the sensing information of the second pedal simulator sensor 240 is within a set range, the controller 260 may brake the vehicle based on an average value of the sensing information of the first pedal simulator sensor 230 and the sensing information of the second pedal simulator sensor 240.

Next, if the difference between the sensing information of the first pedal simulator sensor 230 and the sensing information of the second pedal simulator sensor 240 is within the set range, the controller 260 may brake the vehicle based on one of the sensing information of the first pedal simulator sensor 230 or the sensing information of the second pedal simulator sensor 240.

Meanwhile, if the difference between the sensing information of the first pedal simulator sensor 230 and the sensing information of the second pedal simulator sensor 240 is outside the set range, the controller 260 may brake the vehicle based on a greater value between the sensing information of the first pedal simulator sensor 230 and the sensing information of the second pedal simulator sensor 240. Alternatively, the controller 260 may control the vehicle to stop.

As described above with reference to the first embodiment, the set range may be set to a maximum error between the sensing information of the first pedal simulator sensor 230 and the sensing information of the second pedal simulator sensor 240 when both the first pedal simulator sensor 230 and the second pedal simulator sensor 240 are normal.

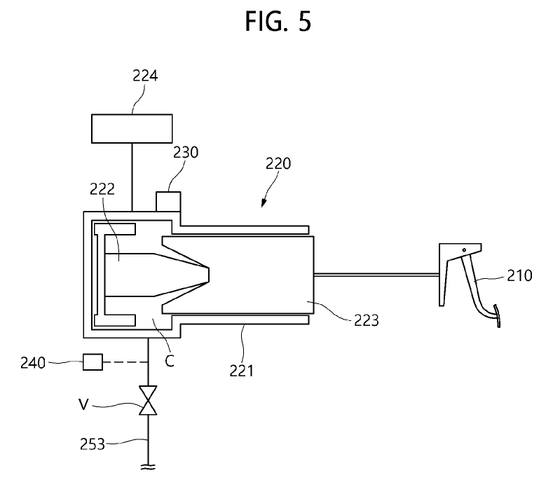

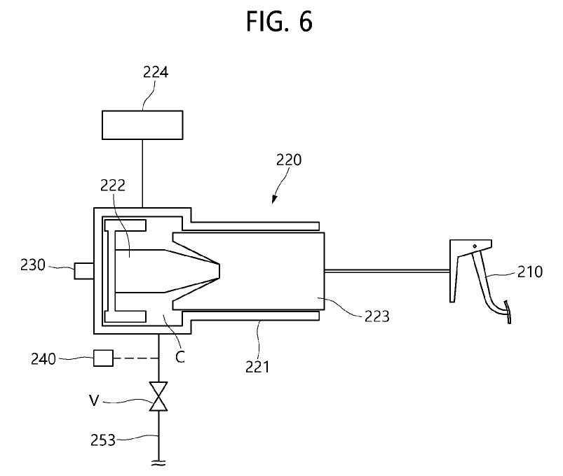

FIG. 5 is a view illustrating another example of a combination of a first pedal simulator sensor and a second pedal simulator sensor of the pedal system for a vehicle according to the second embodiment of the present disclosure. FIG. 6 is a view illustrating still another example of the combination of the first pedal simulator sensor and the second pedal simulator sensor of the pedal system for a vehicle according to the second embodiment of the present disclosure.

Referring to FIGS. 5 and 6, the pedal simulator 220 is configured as a wet type in which the chamber C is filled with a fluid. At this time, the pedal simulator 220 may be connected to an emergency hydraulic circuit 253 capable of delivering the fluid toward at least one wheel when the brake actuation device 250 fails. In addition, the pedal simulator 220 may further include a reservoir 224 for accommodating a flow of the fluid from the chamber C according to displacement of the pedal 210.

When the brake actuation device 250 is in a normal state, a circuit opening/closing valve V disposed in the emergency hydraulic circuit 253 is disposed to close a flow path. At this time, the second pedal simulator sensor 240 may be disposed in the emergency hydraulic circuit 253 between the pedal simulator 220 and the circuit opening/closing valve V. More specifically, the second pedal simulator sensor 240 may detect a flow pressure of the fluid generated when the piston 223 is displaced by a pressure applied to the pedal 210.

Referring to FIG. 5, the first pedal simulator sensor 230 may detect linear displacement of the piston 223, and the second pedal simulator sensor 240 may detect the flow pressure of the fluid.

Referring to FIG. 6, the first pedal simulator sensor 230 may detect a pressure applied to the damper 222, and the second pedal simulator sensor 240 may detect the flow pressure of the fluid.

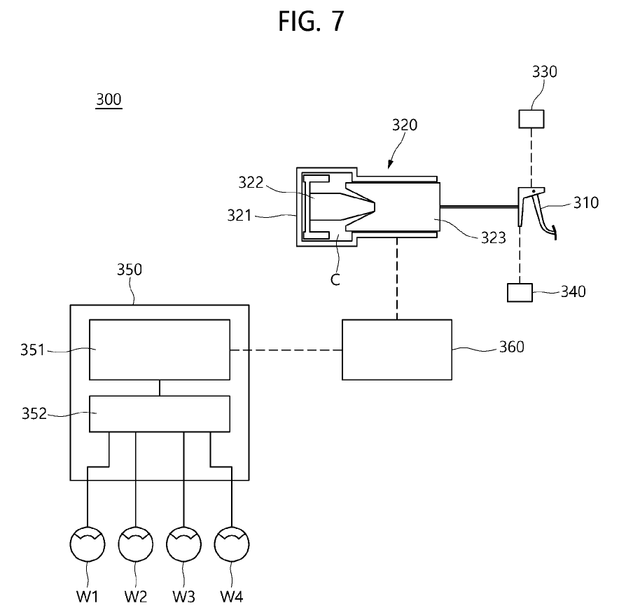

FIG. 7 is a view illustrating a configuration of a pedal system for a vehicle according to a third embodiment of the present disclosure.

A pedal system 300 for a vehicle according to the third embodiment of the present disclosure may brake the vehicle based on operation information of a pedal 310 mounted to the vehicle. In other words, the pedal system 300 for a vehicle may be a brake pedal system of the vehicle.

Referring to FIG. 7, the pedal system 300 for a vehicle according to the third embodiment of the present disclosure includes a pedal 310, a pedal simulator 320, a first pedal sensor 330, a second pedal sensor 340, a brake actuation device 350, and a controller 360.

The pedal 310 is mounted to the vehicle. The pedal 310 may be a brake pedal.

The pedal simulator 320 is connected to the pedal 310 and provides, to the pedal 310, a reaction force corresponding to a pressure applied to the pedal 310.

The pedal simulator 320 may include a housing 321 defining a chamber C therein, a damper 322 disposed inside the housing 321, and a piston 323 connected to the pedal 310 and disposed in the chamber C to press the damper 322 when pressure is applied to the pedal 310.

The first pedal sensor 330 detects information related to operation of the pedal 310. The second pedal sensor 340 is separately disposed from the first pedal sensor 330 and detects information related to operation of the pedal 310. The first pedal sensor 330 and the second pedal sensor 340 may be connected to the pedal 310.

For example, the first pedal sensor 330 may detect linear displacement of the pedal 310, and the second pedal sensor 340 may detect angular displacement of the pedal 310. In addition, the first pedal sensor 330 may detect linear displacement of the pedal 310, and the second pedal sensor 340 may detect a force applied to the pedal 310. Meanwhile, the first pedal sensor 330 may detect angular displacement of the pedal 310, and the second pedal sensor 340 may detect a force applied to the pedal 310.

The brake actuation device 350 performs braking of the vehicle under control of the controller 360. The brake actuation device 350 may supply a fluid to at least one of wheels W1, W2, W3, and W4 of the vehicle to provide a braking pressure.

The brake actuation device 350 may include an actuator 351 generating a pressure of the fluid and a hydraulic circuit 352 regulating a flow of the fluid between the actuator 351 and the wheels W1, W2, W3, and W4 of the vehicle.

The controller 360 brakes the vehicle using at least one of sensing information of the first pedal sensor 330 or sensing information of the second pedal sensor 340.

First, if a difference between the sensing information of the first pedal sensor 330 and the sensing information of the second pedal sensor 340 is within a set range, the controller 360 may brake the vehicle based on an average value of the sensing information of the first pedal sensor 330 and the sensing information of the second pedal sensor 340.

Next, if the difference between the sensing information of the first pedal sensor 330 and the sensing information of the second pedal sensor 340 is within the set range, the controller 360 may brake the vehicle based on one of the sensing information of the first pedal sensor 330 or the sensing information of the second pedal sensor 340.

Meanwhile, if the difference between the sensing information of the first pedal sensor 330 and the sensing information of the second pedal sensor 340 is outside the set range, the controller 360 may brake the vehicle based on a greater value between the sensing information of the first pedal sensor 330 and the sensing information of the second pedal sensor 340. Alternatively, the controller 360 may control the vehicle to stop.

As described above with reference to the first embodiment and the second embodiment, the set range may be set to a maximum error between the sensing information of the first pedal sensor 330 and the sensing information of the second pedal sensor 340 when both the first pedal sensor 330 and the second pedal sensor 340 are normal.

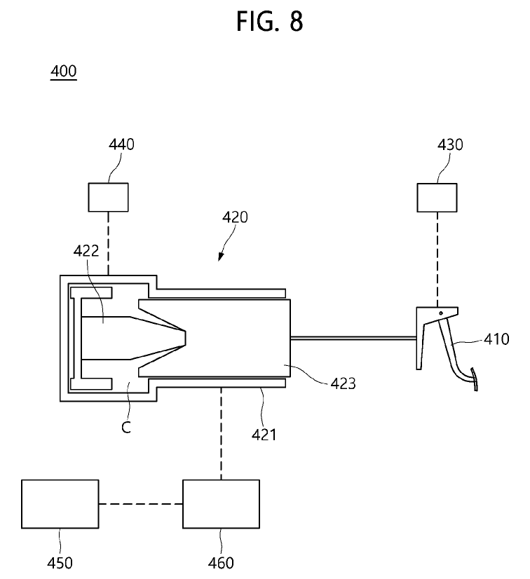

FIG. 8 is a view illustrating a configuration of a pedal system for a vehicle according to a fourth embodiment of the present disclosure.

A pedal system 400 for a vehicle according to the fourth embodiment of the present disclosure may accelerate the vehicle based on operation information of a pedal 410 mounted to the vehicle. In other words, the pedal system 400 for a vehicle may be an accelerator pedal system of the vehicle.

Referring to FIG. 8, the pedal system 400 for a vehicle according to the fourth embodiment of the present disclosure includes a pedal 410, a pedal simulator 420, a first sensor 430, a second sensor 440, an acceleration device 450, and a controller 460.

The pedal 410 is mounted to the vehicle. The pedal 410 may be operated by a driver. In the fourth embodiment of the present disclosure, the pedal 410 may be an accelerator pedal.

The pedal simulator 420 is connected to the pedal 410 and provides, to the pedal 410, a reaction force corresponding to a pressure applied to the pedal 410.

The pedal simulator 420 may include a housing 421 defining a chamber C therein, a damper 422 disposed inside the housing 421, and a piston 423 connected to the pedal 410 and disposed in the chamber C to press the damper 422 when pressure is applied to the pedal 410.

The first sensor 430 detects information related to operation of the pedal 410. The first sensor 430 may be connected to the pedal 410.

The first sensor 430 may detect linear displacement of the pedal 410. Alternatively, the first sensor 430 may detect angular displacement of the pedal 410. Meanwhile, the first sensor 430 may also detect a force applied to the pedal 410.

The second sensor 440 detects information related to operation of the pedal simulator 420. The second sensor 440 may be disposed inside or outside the pedal simulator 420. More specifically, the second sensor 440 may detect linear displacement of the piston 423. Meanwhile, the second sensor 440 may also detect a pressure applied to the damper 422.

The acceleration device 450 performs acceleration of the vehicle under control of the controller 460. The acceleration device 450 may include a powertrain of the vehicle.

The controller 460 may accelerate the vehicle using at least one of sensing information of the first sensor 430 or sensing information of the second sensor 440. For example, the controller 460 may determine a magnitude of displacement of the pedal 410 using at least one of the sensing information of the first sensor 430 or the sensing information of the second sensor 440, and may control the acceleration device 450 such that acceleration corresponding thereto is achieved.

If a difference between the sensing information of the first sensor 430 and the sensing information of the second sensor 440 is within a set range, the controller 460 may accelerate the vehicle based on an average value of the sensing information of the first sensor 430 and the sensing information of the second sensor 440.

For example, the set range may be set to a maximum error between the sensing information of the first sensor 430 and the sensing information of the second sensor 440 when both the first sensor 430 and the second sensor 440 are normal.

In addition, if the difference between the sensing information of the first sensor 430 and the sensing information of the second sensor 440 is within the set range, the controller 460 may also accelerate the vehicle based on one of the sensing information of the first sensor 430 or the sensing information of the second sensor 440.

Meanwhile, if the difference between the sensing information of the first sensor 430 and the sensing information of the second sensor 440 is outside the set range, the controller 460 may accelerate the vehicle based on a smaller value between the sensing information of the first sensor 430 and the sensing information of the second sensor 440.

If the difference between the sensing information of the first sensor 430 and the sensing information of the second sensor 440 is outside the set range, at least one of the first sensor 430 and the second sensor 440 may be regarded as being faulty. Since the pedal system 400 for a vehicle according to the fourth embodiment of the present disclosure is related to acceleration of the vehicle, it is desirable, for safety, that insufficient acceleration rather than excessive acceleration be performed. Accordingly, if the difference between the sensing information of the first sensor 430 and the sensing information of the second sensor 440 is outside the set range, the controller 460 may control the acceleration device 450 such that an acceleration force corresponding to the smaller value between the sensing information of the first sensor 430 and the sensing information of the second sensor 440 is generated.

Alternatively, if the difference between the sensing information of the first sensor 430 and the sensing information of the second sensor 440 is outside the set range, the controller 460 may control the vehicle to stop.

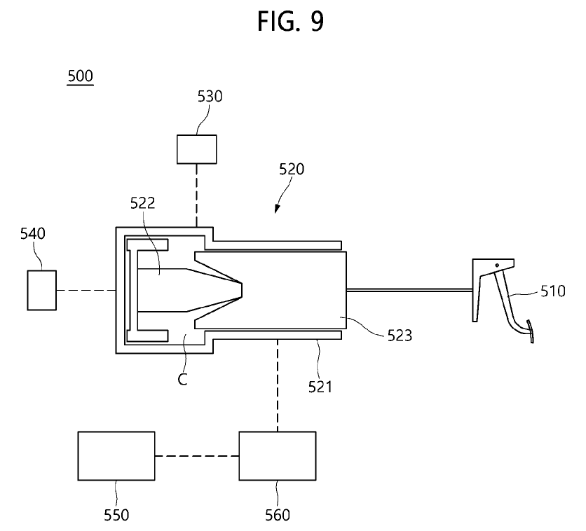

FIG. 9 is a view illustrating a configuration of a pedal system for a vehicle according to a fifth embodiment of the present disclosure.

A pedal system 500 for a vehicle according to the fifth embodiment of the present disclosure may accelerate the vehicle based on operation information of a pedal 510 mounted to the vehicle. In other words, the pedal system 500 for a vehicle may be an accelerator pedal system of the vehicle.

Referring to FIG. 9, the pedal system 500 for a vehicle according to the fifth embodiment of the present disclosure includes a pedal 510, a pedal simulator 520, a first pedal simulator sensor 530, a second pedal simulator sensor 540, an acceleration device 550, and a controller 560.

The pedal 510 may be an accelerator pedal mounted to the vehicle. In addition, the pedal simulator 520 is connected to the pedal 510 and provides, to the pedal 510, a reaction force corresponding to a pressure applied to the pedal 510.

The pedal simulator 520 may include a housing 521 defining a chamber C therein, a damper 522 disposed inside the housing 521, and a piston 523 connected to the pedal 510 and disposed in the chamber C to press the damper 522 when pressure is applied to the pedal 510.

The first pedal simulator sensor 530 is disposed in the pedal simulator 520 and detects information related to operation of the pedal simulator 520. The first pedal simulator sensor 530 may be disposed inside or outside the pedal simulator 520. For example, the first pedal simulator sensor 530 may detect linear displacement of the piston 523.

The second pedal simulator sensor 540 is separately disposed in the pedal simulator 520 from the first pedal simulator sensor 530 and detects information related to operation of the pedal simulator 520. For example, the second pedal simulator sensor 540 may detect a pressure applied to the damper 522.

The acceleration device 550 performs acceleration of the vehicle under control of the controller 560. The acceleration device 550 may include a powertrain of the vehicle.

The controller 560 may control the acceleration device 550 using at least one of sensing information of the first pedal simulator sensor 530 or sensing information of the second pedal simulator sensor 540.

If a difference between the sensing information of the first pedal simulator sensor 530 and the sensing information of the second pedal simulator sensor 540 is within a set range, the controller 560 may accelerate the vehicle based on an average value of the sensing information of the first pedal simulator sensor 530 and the sensing information of the second pedal simulator sensor 540.

In addition, if the difference between the sensing information of the first pedal simulator sensor 530 and the sensing information of the second pedal simulator sensor 540 is within the set range, the controller 560 may accelerate the vehicle based on one of the sensing information of the first pedal simulator sensor 530 or the sensing information of the second pedal simulator sensor 540.

Meanwhile, if the difference between the sensing information of the first pedal simulator sensor 530 and the sensing information of the second pedal simulator sensor 540 is outside the set range, the controller 560 may accelerate the vehicle based on a smaller value between the sensing information of the first pedal simulator sensor 530 and the sensing information of the second pedal simulator sensor 540. Alternatively, the controller 560 may control the vehicle to stop.

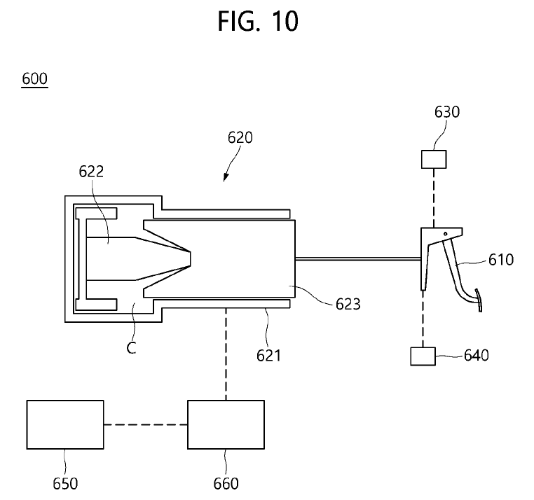

FIG. 10 is a view illustrating a configuration of a pedal system for a vehicle according to a sixth embodiment of the present disclosure.

A pedal system 600 for a vehicle according to the sixth embodiment of the present disclosure may accelerate the vehicle based on operation information of a pedal 610 mounted to the vehicle.

Referring to FIG. 10, the pedal system 600 for a vehicle according to the sixth embodiment of the present disclosure includes a pedal 610, a pedal simulator 620, a first pedal sensor 630, a second pedal sensor 640, an acceleration device 650, and a controller 660.

The pedal 610 may be an accelerator pedal mounted to the vehicle. In addition, the pedal simulator 620 is connected to the pedal 610 and provides, to the pedal 610, a reaction force corresponding to a pressure applied to the pedal 610.

The pedal simulator 620 may include a housing 621 defining a chamber C therein, a damper 622 disposed inside the housing 621, and a piston 623 connected to the pedal 610 and disposed in the chamber C to press the damper 622 when pressure is applied to the pedal 610.

The first pedal sensor 630 detects information related to operation of the pedal 610. The second pedal sensor 640 is separately disposed from the first pedal sensor 630 and detects information related to operation of the pedal 610.

For example, the first pedal sensor 630 may detect linear displacement of the pedal 610, and the second pedal sensor 640 may detect angular displacement of the pedal 610. In addition, the first pedal sensor 630 may detect linear displacement of the pedal 610, and the second pedal sensor 640 may detect a force applied to the pedal 610. Meanwhile, the first pedal sensor 630 may detect angular displacement of the pedal 610, and the second pedal sensor 640 may detect a force applied to the pedal 610.

The acceleration device 650 performs acceleration of the vehicle under control of the controller 660. The acceleration device 650 may include a powertrain of the vehicle.

The controller 660 may control the acceleration device 650 using at least one of sensing information of the first pedal sensor 630 or sensing information of the second pedal sensor 640.

If a difference between the sensing information of the first pedal sensor 630 and the sensing information of the second pedal sensor 640 is within a set range, the controller 660 may accelerate the vehicle based on an average value of the sensing information of the first pedal sensor 630 and the sensing information of the second pedal sensor 640.

In addition, if the difference between the sensing information of the first pedal sensor 630 and the sensing information of the second pedal sensor 640 is within the set range, the controller 660 may accelerate the vehicle based on one of the sensing information of the first pedal sensor 630 or the sensing information of the second pedal sensor 640.

Meanwhile, if the difference between the sensing information of the first pedal sensor 630 and the sensing information of the second pedal sensor 640 is outside the set range, the controller 660 may accelerate the vehicle based on a smaller value between the sensing information of the first pedal sensor 630 and the sensing information of the second pedal sensor 640. Alternatively, the controller 660 may control the vehicle to stop.

With the above configuration, the pedal system for a vehicle according to the present disclosure improves recognition accuracy of pedal operation information of the vehicle through determination based on a plurality of pieces of sensing information.

The pedal system for a vehicle according to the present disclosure secures redundancy related to recognition of pedal operation of the vehicle through a plurality of sensors and improves reliability of a recognition function of pedal operation information.

It should be understood that the effects of the present disclosure are not limited to the above-described effects, and include all effects inferable from a configuration of the invention described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. A pedal system for a vehicle, comprising:
a pedal mounted to the vehicle;
a pedal simulator connected to the pedal and configured to provide, to the pedal, a reaction force corresponding to a pressure applied to the pedal;
a first sensor configured to detect information related to operation of the pedal;
a second sensor configured to detect information related to operation of the pedal simulator; and
a controller configured to operate the vehicle using at least one of sensing information of the first sensor or sensing information of the second sensor.

2. The pedal system of claim 1, wherein the controller is configured to brake or accelerate the vehicle based on an average value of the sensing information of the first sensor and the sensing information of the second sensor if a difference between the sensing information of the first sensor and the sensing information of the second sensor is within a set range.

3. The pedal system of claim 1, wherein the controller is configured to brake or accelerate the vehicle based on one of the sensing information of the first sensor or the sensing information of the second sensor if a difference between the sensing information of the first sensor and the sensing information of the second sensor is within a set range.

4. The pedal system of claim 1,
wherein the pedal is a brake pedal, and
wherein the controller is configured to brake the vehicle based on a greater value between the sensing information of the first sensor and the sensing information of the second sensor if a difference between the sensing information of the first sensor and the sensing information of the second sensor is outside a set range.

5. The pedal system of claim 1,
wherein the pedal is an accelerator pedal, and
wherein the controller is configured to accelerate the vehicle based on a smaller value between the sensing information of the first sensor and the sensing information of the second sensor if a difference between the sensing information of the first sensor and the sensing information of the second sensor is outside a set range.

6. The pedal system of claim 1, wherein the first sensor is configured to detect one of linear displacement of the pedal, angular displacement of the pedal, or a force applied to the pedal.

7. The pedal system of claim 1,
wherein the pedal simulator comprises:
a housing defining a chamber therein;
a damper disposed inside the housing; and
a piston connected to the pedal and disposed in the chamber to press the damper when pressure is applied to the pedal, and
wherein the second sensor is configured to detect linear displacement of the piston or a pressure applied to the damper.

8. The pedal system of claim 1,
wherein the pedal simulator comprises:
a housing defining a chamber filled with a fluid therein; and
a piston connected to the pedal and disposed in the chamber to cause the fluid to flow when pressure is applied to the pedal, and
wherein the second sensor is configured to detect a flow pressure of the fluid.

9. A pedal system for a vehicle, comprising:
a pedal mounted to the vehicle;
a pedal simulator connected to the pedal and configured to provide a reaction force corresponding to a pressure applied to the pedal;
a first pedal simulator sensor disposed in the pedal simulator and configured to detect information related to operation of the pedal simulator;
a second pedal simulator sensor separately disposed in the pedal simulator from the first pedal simulator sensor and configured to detect information related to operation of the pedal simulator; and
a controller configured to operate the vehicle using at least one of sensing information of the first pedal simulator sensor or sensing information of the second pedal simulator sensor.

10. The pedal system of claim 9,
wherein the pedal is a brake pedal, and
wherein the controller is configured to brake the vehicle based on a greater value between the sensing information of the first pedal simulator sensor and the sensing information of the second pedal simulator sensor if a difference between the sensing information of the first pedal simulator sensor and the sensing information of the second pedal simulator sensor is outside a set range.

11. The pedal system of claim 9,
wherein the pedal is an accelerator pedal, and
wherein the controller is configured to accelerate the vehicle based on a smaller value between the sensing information of the first pedal simulator sensor and the sensing information of the second pedal simulator sensor if a difference between the sensing information of the first pedal simulator sensor and the sensing information of the second pedal simulator sensor is outside a set range.

12. The pedal system of claim 9,
wherein the pedal simulator comprises:
a housing defining a chamber therein;
a damper disposed inside the housing; and
a piston connected to the pedal and disposed in the chamber to press the damper when pressure is applied to the pedal, and
wherein the first pedal simulator sensor is configured to detect linear displacement of the piston, and the second pedal simulator sensor is configured to detect a pressure applied to the damper.

13. The pedal system of claim 9,
wherein the pedal simulator comprises:
a housing defining a chamber filled with a fluid therein; and
a piston connected to the pedal and disposed in the chamber to cause the fluid to flow when pressure is applied to the pedal, and
wherein the first pedal simulator sensor is configured to detect linear displacement of the piston, and the second pedal simulator sensor is configured to detect a flow pressure of the fluid.

14. The pedal system of claim 9,
wherein the pedal simulator comprises:
a housing defining a chamber filled with a fluid therein;
a damper disposed inside the housing; and
a piston connected to the pedal and disposed in the chamber to press the damper and cause the fluid to flow when pressure is applied to the pedal, and
wherein the first pedal simulator sensor is configured to detect a pressure applied to the damper, and the second pedal simulator sensor is configured to detect a flow pressure of the fluid.

15. A pedal system for a vehicle, comprising:
a pedal mounted to the vehicle;
a pedal simulator connected to the pedal and configured to provide a reaction force corresponding to a pressure applied to the pedal;
a first pedal sensor configured to detect information related to operation of the pedal;
a second pedal sensor separately disposed from the first pedal sensor and configured to detect information related to operation of the pedal; and
a controller configured to operate the vehicle using at least one of sensing information of the first pedal sensor or sensing information of the second pedal sensor.

16. The pedal system of claim 15,
wherein the pedal is a brake pedal, and
wherein the controller is configured to brake the vehicle based on a greater value between the sensing information of the first pedal sensor and the sensing information of the second pedal sensor if a difference between the sensing information of the first pedal sensor and the sensing information of the second pedal sensor is outside a set range.

17. The pedal system of claim 15,
wherein the pedal is an accelerator pedal, and
wherein the controller is configured to accelerate the vehicle based on a smaller value between the sensing information of the first pedal sensor and the sensing information of the second pedal sensor if a difference between the sensing information of the first pedal sensor and the sensing information of the second pedal sensor is outside a set range.

18. The pedal system of claim 15, wherein the first pedal sensor is configured to detect linear displacement of the pedal, and the second pedal sensor is configured to detect angular displacement of the pedal.

19. The pedal system of claim 15, wherein the first pedal sensor is configured to detect linear displacement of the pedal, and the second pedal sensor is configured to detect a force applied to the pedal.

20. The pedal system of claim 15, wherein the first pedal sensor is configured to detect angular displacement of the pedal, and the second pedal sensor is configured to detect a force applied to the pedal.
